(19) United States
(12) Patent Application Publication
(10) Pub. No.: US 2015/0046230 A1
(43) Pub. Date: Feb. 12, 2015

(54) SYSTEM AND METHOD OF EVALUATING INFORMATION TECHNOLOGY (IT) SYSTEMS

(71) Applicant: I.T. ANALYZER LTD., Nes Ziona (IL)

(72) Inventors: Ofer LAKSMAN, Yavne (IL); Tsafrir LAHAV, Nes-Ziyyona (IL); Pablo HORENSTEIN, Rishon Le Zion (IL); Gregry KOVALEV, Rishon Lezion (IL); Oleg KOVALEV, Rehovot (IL); Vladimir LYUBARSKY, Rehovot (IL)

(21) Appl. No.: 14/453,649

(22) Filed: Aug. 7, 2014

Related U.S. Application Data
(60) Provisional application No. 61/863,458, filed on Aug. 8, 2013.

(51) Int. Cl. G06Q 10/06; G06F 17/30; G06F 11/14

(52) U.S. Cl. CPC G06Q 10/06393; G06F 11/1402; G06F 17/30386; G06F 17/30091
USPC 705/7.39

(57) ABSTRACT

A system and a method of evaluating information technology (IT) infrastructure. The evaluation method may include receiving a value of an IT infrastructure parameter, for example, a value of a data protection parameter, a value of service availability parameter and/or a value of the IT investment parameter, for a first IT infrastructure. A business profile associated with a user of said first IT infrastructure may be received and a plurality of IT infrastructures associated with said received business profile may be identified. For each of said identified plurality of IT infrastructures representative values of IT infrastructure parameter may further be identified. The evaluation may include comparing said received value with said representative values.

### CROSS REFERENCE TO RELATED APPLICATIONS

This application claims the benefit of U.S. Provisional application Ser. No. 61/863,458, filed on Aug. 8, 2013 which is incorporated in its entirety herein by reference.

### BACKGROUND OF THE INVENTION

Many organizations, such as banks, telecommunications providers, insurance companies, or the like, periodically reevaluate their information technology (IT) infrastructures, in matters of resources, performance, availability, etc. Currently, in order to compare these aspects of their IT infrastructure to other organizations having a similar business profile (e.g., competitors), an organization may hire a consultant who gives the organization a recommendation as to how to improve its IT infrastructure. The consultant may have a limited database that includes his/her clients only, and is therefore limited in the amount and quality of the data he/she can provide.

### SUMMARY OF THE INVENTION

Some aspects of the invention may be directed to a system and a method of evaluating information technology infrastructure. The method may include receiving a value of a data protection parameter for a first IT infrastructure and receiving a business profile associated with a user of the first IT infrastructure. The method may further include identifying a plurality of IT infrastructures associated with the received business profile and further identifying representative values of the data protection parameter for each of the identified plurality of IT infrastructures. In order to evaluate the IT infrastructure a comparisons may be made between the received value and the representative values.

Some additional aspects of the invention may be directed to a system and a method of evaluating information technology infrastructure. The method may include receiving a value of a service availability parameter for a first IT infrastructure and receiving a business profile associated with a user of the first IT infrastructure. The method may further include identifying a plurality of IT infrastructures associated with the received business profile and further identifying representative values of the service availability parameter for each of the identified plurality of IT infrastructures. In order to evaluate the IT infrastructure a comparisons may be made between the received value and the representative values.

Some aspects of the invention may be directed to a system and a method of evaluating information technology infrastructure. The method may include receiving a value of an IT investment parameter for a first IT infrastructure and receiving a business profile associated with a user of the first IT infrastructure. The method may further include identifying a plurality of IT infrastructures associated with the received business profile and further identifying representative values of the IT investment parameter for each of the identified plurality of IT infrastructures. In order to evaluate the IT infrastructure a comparisons may be made between the received value and the representative values.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is an illustration of a high level block diagram of an exemplary computing device according to some embodiments of the present invention;

FIG. 1B is an illustration of a high level block diagram of an IT infrastructure according to some embodiments of the present invention; and

FIGS. 2A-2C are flowcharts of methods of evaluating information technology infrastructures according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

Embodiments of the present invention include a system and method of evaluating information technology (IT) infrastructures of an organization in comparison to information technology infrastructures of other organizations having at least one business profile similarity, for example, a business core. An IT and/or managerial person in an organization, such as a bank, telecommunication provider, high-tech company, insurance company, governmental institute and others, may periodically evaluate aspects of the IT infrastructure(s) of the organization. Such aspects may be or include IT investment, a data protection policy, service availability or the like.

An IT infrastructure in some embodiments may include IT components particular to, owned by, associated with, or operating to serve a particular organization. An IT infrastructure according to some embodiments of the invention may include, for example, aspects related to the IT equipment (software and/or hardware) used by the organization, IT personnel (number and/or role), IT policy and IT procedures that are implemented in the organization. Some exemplary aspects may include IT budget, IT staff, IT components, aging of technology, number of vendors, data protection policy and procedures and/or the availability policy and procedures of the IT services. Other or different elements may be included in IT infrastructures according to embodiments of the present invention.

Some embodiments of the invention may allow an online comparison of at least one aspect of the IT infrastructure of the organization to aspects of IT infrastructure of other organizations. As used herein, an online comparison is a comparison conducted over the internet in real time, when a user associated with a particular organization having an IT infrastructure logs into the system. The User may enter data related to a business profile of the organization and further at least one value of an IT infrastructure parameter, for example, a value of: IT investment parameters, a data protection parameter, a service availability parameter or the like. Embodiments of a system may compare one or more values of one or more parameters of the subject organization to values of IT infrastructure parameters of other organizations having similar business profiles. For example, a bank having 100,000 customers may compare a value of its IT investment parameter (e.g., a ratio of total budget related to the IT investment segmentation, etc.) to a parameter of other banks having, for example, 70,000-150,000 customers. The information regarding values of IT investment parameters of the other banks may have been gathered from the other banks when such other banks shared this information by saving their own IT investment parameter values in a database.

In some embodiments, the system may display to the user a recommendation as to how to improve various aspects of the organization IT infrastructure, based on the comparison between the organization's value of IT infrastructure parameter with values of the other organizations. The recommendation may include a required change in at least one aspect related to the IT infrastructure. For example, the recommendation may include increase of virtualization ratio of servers, implement clustering technologies, extend the amount of available memory, increase or decrease the backup frequency, increase or decrease the percentage of IT budget from the organization's total budget, or other parameters.

In some embodiments, the organization may not be willing to expose their exact IT related data, for example, budget, number and type of IT components, amount of data and personnel. Therefore, in some embodiments, a value, such as a ratio or metric of a parameter may be entered rather than the absolute data about the IT infrastructure. Furthermore, since different organizations use different metrics (e.g., solutions, products, policies and procedures) to solve similar problems or characterize IT services, metrics or parameters may be defined in common terms, units or values of the given parameter. The value of IT infrastructure parameter may include a mathematical manipulation of data relating to IT infrastructure. The value may include one or more values for parameters such as IT investment rates, the data protection equipment or policies, service availability or other aspects of IT infrastructure use and management.

As used herein, a value of an IT investment parameter may include any value, number and/or mathematical manipulation related to the resources that the organization invests in the IT infrastructure. Some exemplary resources may be, IT budget, IT staff, IT components, aging of technology, number of vendors, placement or, numbers of, or capability of hardware such as servers, switches, storage software layers, backup, clustering, virtualization and cloud services. An exemplary value of the IT investment parameter may include: CPU and memory allocation to virtual servers, data storage redundancy ratio, number of system and/or storage administrators, percentage of cloud services and a percentage of budget rates per employee or per revenue, or other mathematical manipulation of such parameters. Some exemplary parameters for IT infrastructures A-I of various telecommunication providers are given in table 1; other structures which may be used with embodiments of the present invention may have other parameter values, and other or different parameters may be used.

TABLE 1

| | CPU Usage | | | Storage | | | | |
|---|---|---|---|---|---|---|---|---|
| | (Count x | Memory | VM's per | Redundancy | Sys- | Storage | % of Cloud | % IT |
| IT | Cores) | (GB) | CPU* | Ratio | admins ** | Admins | Services | Budget |
| A | 2000 | 1200 | 4 | 70 | 4 | 2 | 20 | 30 |
| B | 1500 | 1500 | 2 | 60 | 2 | 2 | 30 | 20 |
| C | 100 | 1000 | 6 | 40 | 1 | 1 | 40 | 10 |
| D | 500 | 2000 | 3 | 80 | 5 | 3 | 15 | 25 |
| E | 2500 | 3000 | 7 | 40 | 3 | 2 | 50 | 35 |
| F | 1000 | 1200 | 3 | 30 | 2 | 1 | 40 | 10 |
| G | 200 | 300 | 1 | 10 | 1 | 0 | 90 | 5 |
| H | 400 | 600 | 4 | 40 | 3 | 2 | 10 | 30 |
| I | 800 | 900 | 5 | 70 | 2 | 1 | 40 | 35 |

*VM—Virtual Machine representing server virtualization
** Sysadmins—the system administrators

As used herein, a value of a data protection parameter may include a value, number and/or mathematical manipulation of a value or number that is related to a solution, product, policy and procedure implemented by the organization that is aimed to protect valuable data. Some exemplary value of the data protection parameters may include: a frequency of data protection, data retention periods, number of local/remote copies per ‘data set’ and percentage of data protection from the overall data. Some exemplary values of data protection parameters of IT infrastructures A-I of various telecommunication providers are given in table 2.

TABLE 2

| | Backup | Backup | | | | | % of | % of |
|---|---|---|---|---|---|---|---|---|
| | Frequen- | Retention | Local Data | DR Data | Storage | % Data | FS* | Image |
| IT | cy (Hrs) | (Months) | Copies | Copies | Snapshots | Coverage | Based | Based |
| A | 18 | 12 | 5 | 2 | 5 | 80 | 50 | 50 |
| B | 24 | 18 | 4 | 3 | 7 | 90 | 40 | 60 |
| C | 12 | 36 | 3 | 4 | 10 | 95 | 60 | 40 |
| D | 8 | 72 | 7 | 5 | 6 | 75 | 30 | 70 |
| E | 4 | 60 | 4 | 3 | 4 | 90 | 75 | 25 |
| F | 1 | 48 | 2 | 7 | 9 | 85 | 35 | 65 |
| G | 24 | 6 | 1 | 1 | 2 | 99 | 70 | 30 |
| H | 12 | 12 | 4 | 3 | 4 | 90 | 40 | 60 |
| I | 1 | 24 | 2 | 2 | 5 | 75 | 60 | 40 |

*FS—File System where data is stored

As used herein, a value of a service availability parameter may include a value, number and/or mathematical manipulation of a value or number related to solutions, products, policies and procedures implemented by the organization that are aimed to maximize the time where IT infrastructure is up and running. Some exemplary values of the service availability parameters may include: number of multi paths between servers to data stores, percentage of clusters (e.g., the percentage of clusters out of a total sub-set of the protection environment (e.g. servers in production environment or server list supporting defined critical applications)), percentage of virtual high availability (HA) modules, percentage of storage redundancy, percentage of storage array enclosure redundancy, percentage of switch redundancy, percentage of multipathing (e.g., access paths between servers and data), disaster recovery (DR) site distance from production site. Some exemplary values of the service availability parameters of various IT infrastructures A-I of telecommunication providers are given in table 3 (other values and other parameters may be used).

TABLE 3

| | | | | | | | DR* | |
|---|---|---|---|---|---|---|---|---|
| | % | % Virtual | % Disk | % Enclosure | % Switch | % | Distance | DR |
| IT | Clusters | HA | Redundancy | Redundancy | Redundancy | Multiphating | (Km) | Paths |
| A | 30 | 70 | 80 | 20 | 30 | 30 | 20 | 2 |
| B | 20 | 80 | 60 | 10 | 20 | 40 | 5 | 1 |
| C | 10 | 50 | 40 | 30 | 30 | 20 | 1000 | 2 |
| D | 60 | 60 | 50 | 50 | 40 | 40 | 200 | 1 |
| E | 40 | 80 | 30 | 30 | 30 | 50 | 1 | 2 |
| F | 50 | 90 | 70 | 60 | 50 | 30 | 25 | 1 |
| G | 0 | 100 | 40 | 0 | 0 | 0 | 0 | 0 |
| H | 20 | 50 | 70 | 20 | 40 | 30 | 40 | 1 |
| I | 30 | 70 | 40 | 40 | 50 | 40 | 2000 | 2 |

*DR—disaster recovery

In some embodiments, the evaluation of the IT infrastructure of an organization may be done by comparing value(s) of IT infrastructure parameter with values of IT infrastructure parameters associated with other organizations having similar business profiles. As used herein, a business profile may include data representing an aspect or aspects that are related to for example the policy, operation, size, goals, revenue and agenda of the business, and/or other parameters. For example, a business profile may include: a business segment or industry, financial data related to the organization (e.g., the total budget of the organization, the capital turnover, etc.), a location of the organization, an orientations to small office/home office (SOHO), small and medium business (SMB) or enterprise customers, a number of customers, a number of employees, a structure of the organization, customers' satisfaction goals or the like.

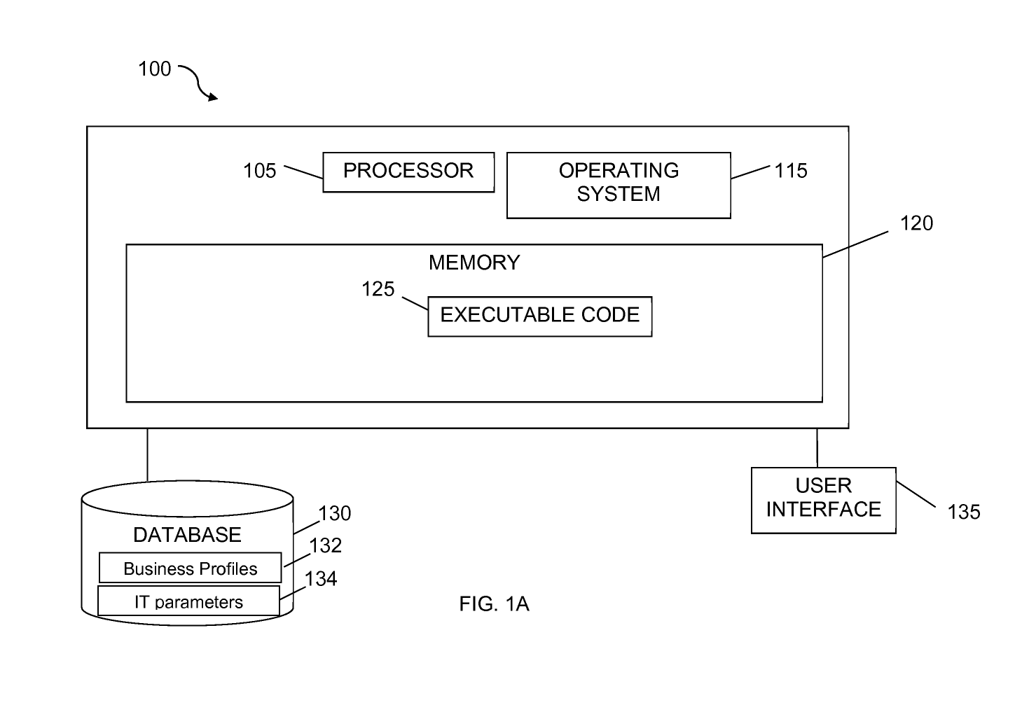

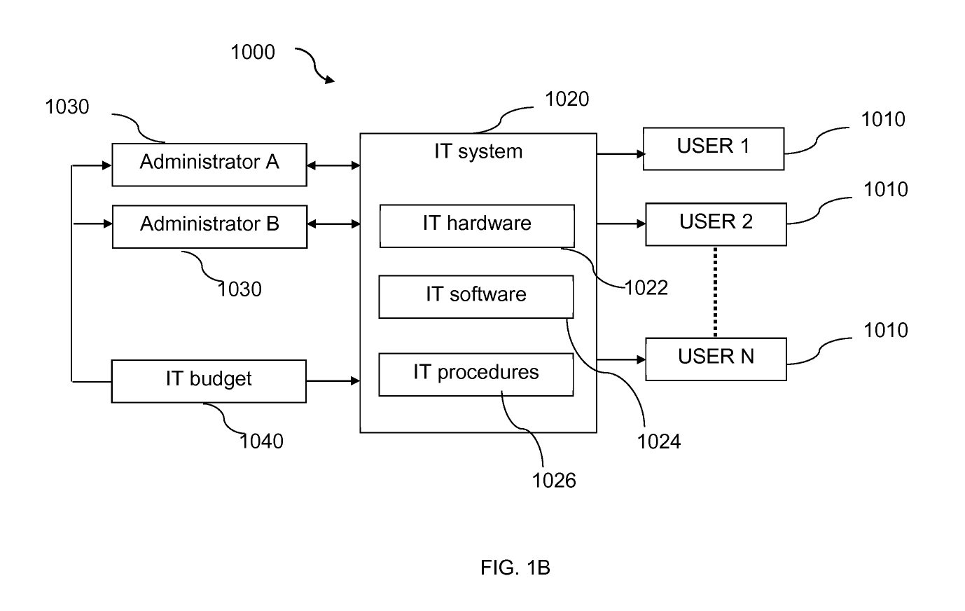

Reference is made to FIG. 1A, showing a high level block diagram of an exemplary computing device according to some embodiments of the present invention. Computing device 100 may include a processor 105 that may be, for example, a central processing unit processor (CPU), a chip or any suitable computing or computational device, an operating system 115, a memory 120, database 130, and a user interface 135. Computing device 100 may be included in system for evaluating information technology infrastructures.

Operating system 115 may be or may include any code segment designed and/or configured to perform tasks involving coordination, scheduling, arbitration, supervising, controlling or otherwise managing operation of computing device 100, for example, scheduling execution of programs. Operating system 115 may be a commercial operating system. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units.

Executable code 125 may be any executable code, e.g., an application, a program, a process, task or script. Executable code 125 may include code or instructions for evaluating information technology infrastructures. Executable code 125 may be executed by processor 105 possibly under control of operating system 115. Processor 105 may be configured to carry out embodiments of the present invention for example by executing executable code 125.

Database 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in database 130 and may be loaded from database 130 into memory 120 where it may be processed by controller 105. Database 130 may include stored business profiles 132, each associated with an IT infrastructure. Database 130 may include stored IT parameters 134, For example, IT parameters 134 may include values of data protection parameters, values of IT investment parameters and/or values service availability parameters of the IT infrastructures associated with business profiles included in business profiles 132. Such values may be associated with an organization or profile of an organization, using for example, look up tables or other data structures included in Business profiles 132 and IT parameters 134. Organizations may be associated with at least one business profile using for example, additional look up tables stored in database 130.

User Interface 135 may be or may include input devices such as, a mouse, a keyboard, a touch screen or pad or any suitable input device. It will be recognized that any suitable number of input devices may be included in user interface 135. User interface 135 may further include output devices such as: one or more displays, speakers and/or any other suitable output devices. It will be recognized that any suitable number of output devices may be included in user interface 135. Any applicable input/output (I/O) devices may be connected to computing device 100 as shown by block 135. For example, a wired or wireless network interface card (NIC), a modem, printer or facsimile machine, a universal serial bus (USB) device or external hard drive may be included in user interface 135.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

Some embodiments may be provided in a computer program product that may include a non-transitory machine-readable medium, stored thereon instructions, which may be used to program a computer, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein, for example, method of evaluating information technology infrastructures. The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a tablet computer, a network device, or any other suitable computing device. Unless explicitly stated, the method embodiments described herein are not constrained to a particular order or sequence. Additionally, some of the described method embodiments or elements thereof can occur or be performed at the same point in time.

An exemplary IT infrastructure, according to some embodiments of the invention, is diagrammatically presented in FIG. 1B. An IT infrastructure 1000 may be included in or operated by an organization and may provide IT services to N users 1010 associated with the organization. IT infrastructure 1000 may include an IT system 1020, IT administrators 1030 and an IT budget 1040. User 1010 may be an employee of the organization, a client of the organization, an agent of the organization, a supplier of the organization or any person associated with the organization, that uses the organization's IT.

In some embodiments, IT system 1020 may include IT hardware 1022, IT software 1024 and IT procedures 1026. IT hardware 1022 may include any hardware component that support the IT system, for example, servers, computers, switches, networks, storage software layers, backup, clustering, virtualization and cloud services, number of multi paths between servers to data stores. IT software 1024 may include ant software component (i.e., code, algorithm, or the like) that supports the IT system 1020, for example, clustering, load balance, storage virtualization layers and data replication solutions. IT procedures 1026 may include any procedure and/or policy that is implemented in the IT system, for example, a frequency of data protection, data retention periods, number of local/remote copies per ‘data set’, percentage of data protection from the overall data, percentage of clusters, percentage of virtual high availability (HA) modules, percentage of storage redundancy, percentage of storage array enclosure redundancy, percentage of switch redundancy and/or percentage of multipathing (e.g., access paths between servers and data).

The IT infrastructure may further include the personnel or data regarding the personnel (e.g., number of employees and/or outsourcing supplier's) that support the IT system. Two exemplary administrators 1030 are illustrated in FIG. 1B, however any number of administrators or other IT personnel that support IT system 1020 may be included in IT infrastructure 1000. All the above may be correspond to IT budget 1040 that may cover all the IT expenses of the organization.

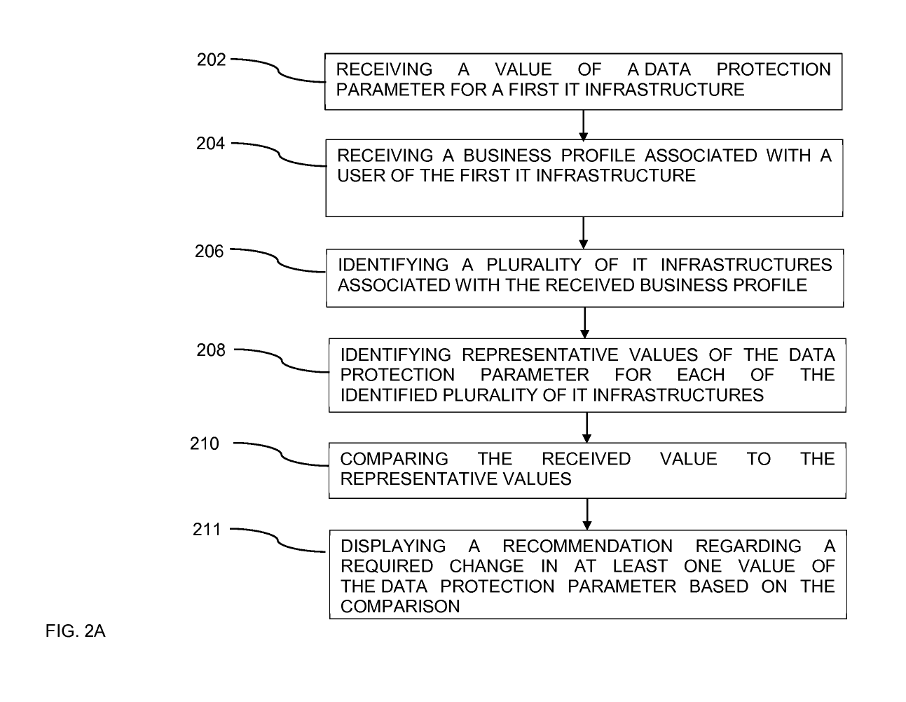

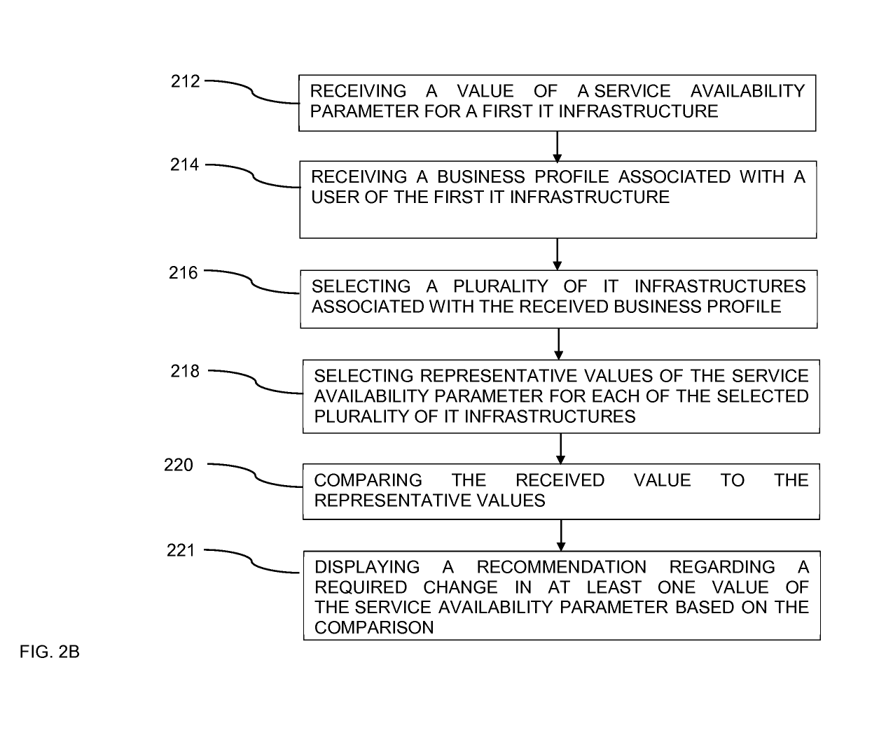

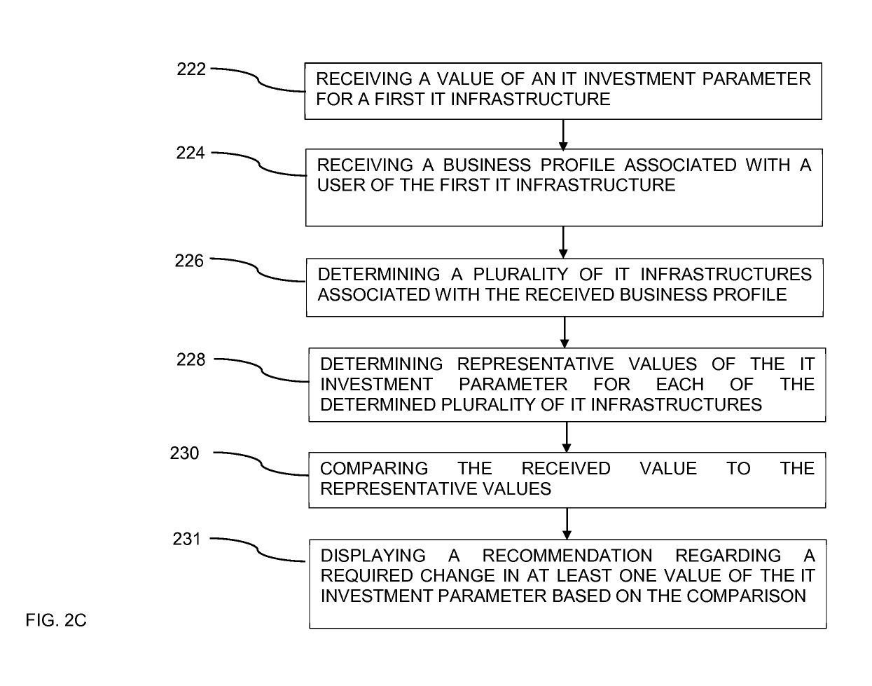

Reference is made to FIGS. 2A-2C, flowcharts of methods of evaluating information technology infrastructures according to some embodiments of the invention. The methods of FIGS. 2A-2C may be performed for example by a system such as system 100. Instructions for executing the methods of FIGS. 2A-2C may be stored in non-transitory machine-readable medium(s), for example, in memory 120, to be used to program a computer, or other programmable devices, to perform the methods.

In the flowchart of FIG. 2A, in operation 202, a value of a data protection parameter of a first IT infrastructure may be received. The IT infrastructure may be associated with an organization. The organization may be any organization, business, institute or the like that uses the IT infrastructure. The value of data protection parameter may include any numeric value that represents at least one aspect of the organization's data protection solutions, products, policies and procedures.

Some exemplary values of data protection parameters may include: a backup frequency, a backup retention, a storage snapshots (e.g., point in time recovery), the percentage of data coverage, a number of disaster recovery data copies, percentage of file system (FS) where data is stored and/or level of image based (e.g., data recovery granularity). Additionally or alternatively, the value of data protection parameter may include a combination of two or more of the exemplary values listed above, or other values or parameters. The combination may include a mathematical manipulation of two or more of the values. For example, a user associated with the organization (e.g., an IT personnel or a managerial personnel) logging into a system (e.g., via user interface 135) performing operation 202, may enter information that the organization uses an average backup frequency for critical systems every 4 hours and/or has an average of 4 disaster recovery data copies for production environment. Alternatively, the user may enter any other value that is representative of the backup frequency and/or the DR data copies.

In operation 204, at least one business profile associated with the user of a first IT infrastructure may be received, e.g., from the user. A business profile may include for example the organization's business core, number of customers, number of employees, structure of the organization, financial data related to the organization and/or customer's satisfaction rating. A business core may include the business segment or the organization's business description, category or focus, for example, finance, telecommunication, energy providers, or the like, and sub-segments, for example, cellular telecommunication, baking, insurance, electricity providers and gas providers. Some, exemplary business core profiles are given in table 4, below. For example, a user using the system may enter data into a business profile describing that the organization is a bank, having 50,000 employees and 500 branches, working with SOHO customers.

In operation 206, other IT infrastructures associated with the received business profile may be identified, selected or determined. Various business profiles each associated with an IT infrastructure may be stored in a database, for example, database 130. The business profiles each associated with an IT infrastructure may be stored in a lookup table or other data structure in database 130. The various business profiles may include for example: a business core (of the organization), number of customers, number of employees, structure of the organization, financial data related to the organization and customer's satisfaction rating, and or other values or parameters. Table 4 is an exemplary lookup table that associated IT infrastructures with various business profiles.

TABLE 4

| IT | | | | |
|---|---|---|---|---|
| infra- | | Sub | | Organization |
| structure | Business Core | Segment | Location | Size |
| A | Telecommunication | Cellular | EU | Medium |
| B | Telecommunication | Cellular | EU | Medium |
| C | Telecommunication | Cellular | ASIA | Medium |
| D | Telecommunication | Cellular | AMERICAS | Large |
| E | Telecommunication | Cellular | AMERICAS | Large |
| F | Telecommunication | Cellular | AMERICAS | Large |
| G | Telecommunication | ISP | ASIA | Small |
| H | Telecommunication | ISP | ASIA | Medium |
| I | Telecommunication | ISP | ASIA | Medium |
| J | Telecommunication | ISP | AMERICAS | Medium |
| K | Telecommunication | ISP | AMERICAS | Large |
| L | Telecommunication | ISP | AMERICAS | Large |
| M | Finance | Banking | ASIA | Large |
| N | Finance | Banking | ASIA | Large |
| O | Finance | Banking | ASIA | Medium |
| P | Finance | Banking | AMERICAS | Large |
| Q | Finance | Banking | AMERICAS | Medium |
| R | Finance | Banking | EU | Large |
| S | Finance | Insurance | ASIA | Small |
| T | Finance | Insurance | ASIA | Medium |
| U | Finance | Insurance | ASIA | Medium |
| V | Finance | Insurance | AMERICAS | Large |
| W | Finance | Insurance | AMERICAS | Medium |
| X | Finance | Insurance | EU | Large |
| Y | Energy | Electric | ASIA | Medium |
| Z | Energy | Electric | ASIA | Small |
| AA | Energy | Electric | AMERICAS | Large |
| AB | Energy | Gas | ASIA | Small |
| AC | Energy | Gas | ASIA | Large |
| AD | Energy | Gas | AMERICAS | Medium |

From the various business profiles stored (for example, in lookup table 4) the business profiles that are similar to the received business profile may be identified and optionally grouped together. For example, if the received business profile is a finance institute providing insurance to customers in Asia, IT infrastructures S, T and U may be identified. In another example, if the received business profile is a telecommunication cellular provider, IT infrastructures A-F may be identified. In yet another example, taken from a different lookup table, if the received business profile is of a telecommunication provider, having 1,000,000 customers, then telecommunication providers, having 800,000-1,500,000 customers may be identified. The business profile identified does not have to be identical to the subject profile in order to be identified in operation 206. It may rather be similar or within a predetermined range of at least one aspect of the received business profile.

In operation 208, representative values of the data protection parameter for each of the identified IT infrastructures may be identified. The representative values of the data protection parameter for the identified IT infrastructures may also be stored in the database. A representative value may include an average value, a mean value, medium value, median value, or any other value that may represent the data protection parameter associated with the IT infrastructure. A lookup table, for example, table 2, included in the database may associate representative values of the data protection parameter with an IT infrastructure. For example, for each of the identified telecommunication cellular providers A-F, identified using table 4, various representative values of the data protection parameter may be identified using table 2. The representative values in table 2, may include, for example, the average backup frequency (hours) for each IT infrastructure. In yet another example, representative numbers of disaster recovery data copies for telecommunication providers having 800,000-1,500,000 customers may be identified.

In operation 210, the comparison may be made between the received value and the representative values. For example, a comparison may be made between the received value of 4 disaster recovery data copies to all the representative numbers of disaster recovery data copies of telecommunication providers having 800,000-1,500,000 customers.

In operation 211, a recommendation regarding a required change in at least one value of the data protection parameter based on the comparison may be displayed. The recommendation may include for example a suggested change in at least one aspect, parameter, policy or equipment that has an influence on the data protection level of the organization. In some embodiments, a change may be recommended in: the backup frequency, the backup retention, the storage snapshots, the percentage of data coverage, the disaster recovery data copies, the percentage of file system (FS) where data is stored and/or the percentage of image based. For example, if the comparison may yield that 4 disaster recovery data copies is below the average of disaster recovery data copies of telecommunication providers having 800,000-1,500,000 customers, the recommendation may include a recommended number (e.g., the average number) of DR data copies or a general recommendation to increase the number of DR data copies.

An exemplary data protection recommendation module according to some embodiments of the invention may include for example (other or different recommendations may be included):

A) Defining the level of risk in the following areas:

recovery point objective to data of critical applications, by expressing the maximum time allowed to lose data in case of major data loss incident. Some exemplary, ranges of timeframe may be allowed such as no data loss, in more than 2 hours, 2-4 hours, 4-8 hours, 8-24 hours, or more than 24 hours;

recovery time objective for business applications to recover from disaster, by expressing the minimal time needed to retrieve data from data protection store to application, servers, for example, time such as 5 minutes, 5-30 minutes, more than 1 hour, 1-8 hours, more than 24 hours, more than 72 hours; and

data retention time for critical applications, by expressing the time needed to retain the data protected to be retrieved in a future time, for example: 1 year, 4 years, 7 years, or more.

B) Recommending the following actions:

changing frequency attribute of backup policy from weekly to daily backup to increase recovery point objective (RPO);

changing ‘file system based’ backup policy to ‘image based’ to increase recovery time objective (RTO); and/or

adding tape drives as final chain of monthly backups to achieve more than 7 years of data retention objective, dictated by regulation.

In some embodiments, the value of a data protection parameter of a first IT infrastructure relative to the representative values may be displayed to a user (e.g., via user interface 135). A graph (e.g., a curve, a block diagram, a pie diagram or the like) may be presented to the user that shows the representative values of the data protection parameter, for example, per number of organizations. A mark (e.g., a line, spot, star etc.) may be placed on the graph marking the received value of the data protection parameter.

In the flowchart of FIG. 2B, in operation 212, a value of a service availability parameter of a first IT infrastructure may be received. The first IT infrastructure may be associated with an organization. The organization may be any organization, business, institute or the like that uses the IT infrastructure. The value of service availability parameter may include any numeric value that represents at least one aspect of the organization's service availability, products, policies and procedures.

Some exemplary values of service availability parameter may include: percentage of clusters, percentage of virtual high availability (HA), percentage of disc redundancy, percentage of enclosure redundancy, percentage of switch redundancy, percentage of multiphating, percentage of disaster recovery distance and/or DR paths. A cluster is a mechanism to switch applications between servers to maximize an uptime of the system. Additionally or alternatively, the value of service availability parameter may include a combination of two or more of the exemplary values listed above. The combination may include a mathematical manipulation of two or more of the values. For example, a user associated with the organization (e.g., an IT person or a managerial person) logging into a system that performing operation 212 (e.g., via user interface 135), may enter information that the IT infrastructure includes 30% clusters and 80% switch redundancy. Alternatively, the user may enter any numerical value or other value that is related to the percentage of clusters and percentage of switch redundancy.

Operations 214 and 216 may be substantially similar to operations 204 and 206 disclosed above, thus are not repeated again.

In operation 218, representative values of the service availability parameter for each of the identified, determined or selected plurality of IT infrastructures may be identified, determined or or selected. The representative values of the service availability parameter for each of the selected plurality of IT infrastructures may also be stored in the database. A representative value may include an average value, a mean value, medium value, median value, total value, or any other value that may represent the service availability parameter associated with the IT infrastructure. A lookup table, for example, table 3, include in the database may associate each value of the service availability parameter with an IT infrastructure. For example, for each of the selected telecommunication cellular providers A-F, selected using table 4, various representative values of the service availability parameter may be selected using table 3. The representative values in table 3, may include, for example, the medium DR distance (e.g., in km) for each IT infrastructure. In yet another example, a percentage of clusters for all the telecommunication providers having 800,000-1,500,000 customers may be identified.

In operation 220, a comparison may be made between the received value and the representative values. For example, a comparison may be made between the received value of 30% clusters and all the representative percentages of clusters of all the telecommunication providers having 800,000-1,500,000 customers.

In operation 221, a recommendation regarding a required change in at least one value of the service availability parameter based on the comparison may be displayed. The recommendation may include a suggested change in at least one aspect, parameter, policy or equipment that has an influence on the service availability of the organization.

In some embodiments, a change may be recommended in: the percentage of clusters, the percentage of virtual high availability (HA), the percentage of disc redundancy, the percentage of enclosure redundancy, the percentage of switch redundancy, the percentage of multipathing, the percentage of disaster recovery distance and/or the DR paths. For example, if the comparison may yield that 30% clusters is below the average of cluster percentage for telecommunication providers having 800,000-1,500,000 customers, the recommendation may include a recommended number (e.g., the average number) of clusters percentage or a general recommendation to increase the clusters percentage.

An exemplary service availability recommendation module according to some embodiments of the invention may provide a recommendation that may include for example:

A) Defining the level of risk in the following areas:

level of it infrastructure redundancy, by expressing the implementation of redundancy in all it layers to avoid service down upon single point of failure (SPOF), for example, multi paths from servers, dual physical switches, dual storage ports, or the like;

acceptable downtime for business applications to recover from service delivery failure, expressing the maximum time allowed from an application not delivering service example: time such as continuous service, 30 seconds, 1 minutes, 5 min, 5-30 min and more than 1 hour; and

acceptable downtime to recover from local disaster, by expressing the time needed to recover from local disaster impacting it, for example, 30 min, more than 1 hour, 1-8 hours, more than 24 hours of non-existing DR.

B) Recommending the following actions:

increase redundancy by implementing multipathing solution at server layer, and dual controller at storage front-end;

reduce application downtime by implementing clustering/load balancing (LB) solutions at physical and virtual server layers; and/or

add DR capabilities by replicating data from local to global site with distance smaller than 100 km.

As with other recommendations described herein, other or different information may be included in a recommendation. In some embodiments, the value of the service availability parameter of the first IT infrastructure relative to the representative values may be displayed (e.g., via user interface 135). A graph (e.g., a curve, a block diagram, a pie chart or diagram or the like) may be presented to the user the representative values of the service availability parameter, for example, per number of organizations. A mark (e.g., a line, spot, star etc.) may be placed on the graph marking the received value of the service availability parameter.

In the flowchart of FIG. 2C, in operation 222, a value of an IT investment parameter of a first IT infrastructure may be received. The first IT infrastructure may be associated with an organization. The organization may be any organization, business, institute or the like that uses the IT infrastructure. The value of IT investment parameter may include any numeric value that represents at least one aspect of the organization's IT investment solutions, products, policies and procedures.

Some exemplary values of the IT investment parameter may include for example: CPU usage, available memory, storage redundancy ratio, number of system administrators, number of storage administrators, percentage of cloud services and/or a percentage of IT budget from the organization's budget. Additionally or alternatively, the value of the IT investment parameter may include a combination of two or more of the exemplary values listed above. The combination may include a mathematical manipulation of two or more of the values. For example, a user associated with the organization (e.g., an IT person or a managerial person) logging into a system that performing operation 222 (e.g., via user interface 135), may enter information that the organization uses 1200 GB memory and has 80% storage redundancy ratio. Alternatively, the user may enter any numerical value or other value that is related to the memory volume and/or the percentage of storage redundancy ratio.

Operations 224 and 226 may be substantially similar to operations 204 and 206 disclosed above, therefore are not repeated again.

In operation 228, representative values of the IT investment parameter for each of the identified, determined or selected plurality of IT infrastructures may be identified, determined or selected. The representative values of the IT investment parameter for each of the determined plurality of IT infrastructures may also be stored in the database. A representative value may include an average value, a mean value, medium value, median value, total value, or any other value that may represent the IT investment parameter associated with the IT infrastructure. A lookup table, for example, table 1, included in the database may associate each value of the IT investment parameter with an IT infrastructure. For example, for each of the determined telecommunication cellular providers A-F, determined using table 4, various representative values of the IT investment parameter may be determined using table 1. The representative values in table 1, may include, for example, the total number of system administrators for each IT infrastructure. In yet another example, an amount of available memory space in GB for all the telecommunication providers having 800,000-1,500,000 customers may be identified.

In operation 230, a comparison may be made between the received value and the representative values. For example, a comparison may be made between the received value of 1200 GB and all the representative available memory spaces for all the telecommunication providers having 800,000-1,500,000 customers.

In operation 231, a recommendation regarding a required change in at least one value of the IT investment parameter based on the comparison may be displayed. The recommendation may include a suggested change in at least one aspect, parameter, policy or equipment that has an influence on the IT investment of the organization.

In some embodiments, a change may be recommended in, for example: the CPU usage, the available memory, the storage redundancy ratio, the number of system administrators, the number of storage administrators, the percentage of cloud services and/or the percentage of IT budget from the organization's budget. For example, if the comparison may yield that 1200 GB is below the average of for telecommunication providers having 800,000-1,500,000 customers, the recommendation may include a recommended number (e.g., the average number) of available memory or a general recommendation to increase the available memory.

An exemplary IT investment recommendation module according to some embodiments of the invention may provide a recommendation that may include for example:

A) Defining the level of resource investment in the areas such as:

storage resources, by expressing the way storage resource should be allocated based on application/business criticality, for example, storage type, cost, speed, redundancy and/or technology;

server resources, by expressing the way computing layer such as servers, virtual systems, blade centers and cloud services should be allocated based on application criticality, for example, server resource overhead ratios of physical server allocation to virtual machines; and

infrastructure software and human resources, expressing software products and IT staff to support according to existing investment, for example, virtualization software products, count of IT administrators per server/terabits of storage.

B) Recommending actions such as the following actions:

increase storage efficiency by mapping non-redundant storage to non-critical environments;

increase server efficiency by changing the ratio of VM's to physical server for business applications; and/or

reduce IT infrastructure system/storage administrators to cope existing IT needs.

In some embodiments, the value of the IT investment parameter of the first IT infrastructure relative to the representative values may be displayed (e.g., via user interface 135). A graph (e.g., a curve, a block diagram, a pie diagram or the like) may present to the user the representative values of the IT investment parameter, for example, per number of organizations. A mark (e.g., a line, spot, star etc.) may be placed on the graph marking the received value of the IT investment parameter

Some methods of the present invention may include a combination of any one of operations 202-230. For example, a method according to some embodiments of the present invention may include operations 202-211, 212, 218 and 220. Another method according to some embodiments of the invention may include operations 212-221, 222, 228 and 230. In yet another example, a method according to the present invention may include operations 222-231, 202, 218 and 210. In some embodiments, the method may further include operations 212, 218 and 220.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of evaluating information technology (IT) infrastructure, comprising:
receiving a value of a data protection parameter for a first IT infrastructure;
receiving a business profile associated with a user of said first IT infrastructure;
identifying a plurality of IT infrastructures associated with said received business profile;
identifying representative values of said data protection parameter for each of said identified plurality of IT infrastructures; and
comparing said received value with said representative values.

2. The method of claim 1, wherein value of a data protection parameter comprises at least one of: a backup frequency, a backup retention, a storage snapshots, the percentage of data coverage, disaster recovery (DR) data copies, percentage of file system (FS) where data is stored and percentage of image based.

3. The method of claim 1, further comprising:
displaying a recommendation regarding a required change in at least one value of said data protection parameter based on the comparison.

4. The method of claim 1, wherein the business profile comprises at least one of: a business core, number of customers, number of employees, structure of an organization, financial data related to the organization and customer's satisfaction rating.

5. The method of claim 1, further comprising:
displaying to the user the value of a data protection parameter of said first IT infrastructure relative to said representative values.

6. The method of claim 1, further comprising:
receiving a value of a service availability parameter for said first IT infrastructure;
identifying representative values of said service availability parameter for each of said identified plurality of IT infrastructures; and
comparing said received value of said service availability parameter and said received value of said data protection parameter with said representative values of said service availability parameter and said data protection parameter.

7. A method of evaluating information technology (IT) infrastructure, comprising:
receiving a value of a service availability parameter for a first IT infrastructure;
receiving a business profile associated with a user of said first IT infrastructure;
selecting a plurality of IT infrastructures associated with said received business profile;
selecting representative values of said service availability parameter for each of said selected plurality of IT infrastructures; and
comparing said received value with said representative values.

8. The method of claim 7, wherein said value of said service availability parameter comprises at least one of: percentage of clusters, percentage of virtual high availability (HA), percentage of disc redundancy, percentage of enclosure redundancy, percentage of switch redundancy, percentage of multiphating, percentage of disaster recovery distance and DR paths.

9. The method of claim 7, further comprising:
displaying to the user a recommendation regarding a required change in at least one value of said service availability parameter based on the comparison.

10. The method of claim 7, wherein the business profile comprises at least one of: the organization's business core, number of customers, number of employees, structure of the organization, financial data related to the organization and customer's satisfaction rating.

11. The method of claim 7, further comprising:
displaying to the user the value of said service availability parameter of said first IT infrastructure relative to said representative values.

12. The method of claim 7, further comprising:
receiving a value of an IT investment parameter for said first IT infrastructure;
selecting representative values of said IT investment parameter for each of said identified plurality of IT infrastructures; and
comparing said received value of said IT investment parameter and said service availability parameter with said representative values of said IT investment parameter and said service availability parameter.

13. A method of evaluating information technology (IT) infrastructure, comprising:
receiving a value of an IT investment parameter for a first IT infrastructure;
receiving a business profile associated with a user of said first IT infrastructure;
determining a plurality of IT infrastructures associated with said received business profile;
determining representative values of said IT investment parameter for each of said determined plurality of IT infrastructures; and
comparing said received value with said representative values.

14. The method of claim 13, wherein said value of said IT investment parameter comprises at least one of: CPU usage, available memory, storage redundancy ratio, number of system administrators, number of storage administrators, percentage of cloud services and percentage of IT budget from the organization's budget.

15. The method of claim 14, further comprising:
displaying to the user a recommendation regarding a required change in at least one value of said IT investment parameter based on the comparison.

16. The method of claim 13, wherein business profile comprises at least one of: the organization's business core, number of customers, number of employees, structure of the organization, financial data related to the organization and customer's satisfaction rating.

17. The method of claim 13, further comprising:
displaying to the user the value of said IT investment parameter of said first IT infrastructure relative to said representative values.

18. The method of claim 13, further comprising:
receiving a value of a data protection parameter for said first IT infrastructure;
identifying representative values of said data protection parameter for each of said identified plurality of IT infrastructures; and
comparing said received value of said data protection parameter and said IT investment parameter with said representative values of said data protection parameter and said IT investment parameter.

19. The method of claim 18, further comprising
receiving a value of a service availability parameter for said first IT infrastructure;
identifying representative values of said service availability parameter for each of said identified plurality of IT infrastructures; and
comparing said received value of said service availability parameter, said IT investment parameter and said data protection parameter with said representative values of said service availability parameter, said IT investment parameter and said data protection parameter.
